(19) United States
(12) Patent Application Publication
(10) Pub. No.: US 2003/0235004 A1
(43) Pub. Date: Dec. 25, 2003

(54) Intermittent gear member, intermittent gear mechanism, and magnetic recording and reproduction apparatus including the same

(75) Inventors: Nobutaka Tsuneyoshi, Tokyo (JP); Naoki Tatsumi, Tokyo (JP); Koichi Shimoyama, Atsugi-Shi (JP)

Correspondence Address: Ladas & Parry, 26 West 61st Street, New York, NY, 10023, US

(73) Assignee: MITSUMI ELECTRIC CO., LTD.

(21) Appl. No.: 10/455,685

(22) Filed: Jun. 5, 2003

(30) Foreign Application Priority Data
Jun. 19, 2002 (JP) 2002-178241

(51) Int. Cl. G11B 5/027

(52) U.S. Cl. 360/85

(57) ABSTRACT

An intermittent gear member, which intermittently rotates alternately in first and second opposite rotational directions within an angular range of 360° or less, includes a disk part, a gear part formed over a predetermined angular range on the circumferential surface of the disk part, and a rotation stopper cam part formed on the toothless part of the circumferential surface of the disk part so as to protrude therefrom, the toothless part corresponding to the range other than the range over which the gear part is formed. The gear part and the rotation stopper cam part are provided in the same plane.

### BACKGROUND OF THE INVENTION

1. Field of the Invention

The present invention relates to an intermittent gear member, an intermittent gear mechanism, and a magnetic recording and reproduction apparatus using the same.

2. Description of the Related Art

FIGS. 1A and 1B are diagrams showing a conventional intermittent gear mechanism 10. The intermittent gear mechanism 10 includes an intermittent gear member 20 as a driven gear member and a gear member 30 as a driving gear member. The intermittent gear member 20 includes a gear part 21 formed over the range of an angle of α1, a concave arcuate rotation stopper cam part 22 formed over the range of an angle of α2, and a mechanism gear part 23. The rotation stopper cam part 22 and the gear part 21 are provided at different levels. The mechanism gear part 23 is provided at a higher level than the rotation stopper cam part 22. The gear member 30 includes a gear part 31 opposing the gear part 21 and a convex arcuate cam part 32 opposing the rotation stopper cam part 22.

Initially, the gear part 21 and the gear part 31 are engaged with each other. When the gear member 30 is rotated in the direction of the arrow A₁, the intermittent gear member 20 is rotated in the direction of the arrow B₁. When the intermittent gear member 20 is rotated approximately an angle of α1, at the same time that the gear part 31 disengages the gear part 21, the rotation stopper cam part 22 fits with the cam part 32. As a result, the rotation of the intermittent gear member 20 is restricted, so that the intermittent gear member 20 stops and stays in this rotational position. When the gear member 30 starts rotating in the reverse direction indicated by arrow A₂, the intermittent gear member 20 remains stationary. As the gear member 30 is rotated, the cam part 32 disengages the rotation stopper cam part 22, so that the gear part 31 engages the gear part 21 so as to start rotating the intermittent gear member 20 in the direction of the arrow B₂. The mechanism gear part 23 causes a mechanism to operate.

FIGS. 2A and 2B are diagrams showing another conventional intermittent gear mechanism 40. The intermittent gear mechanism 40 includes an intermittent gear member 50 as a driven gear member and a gear member 60 as a driving gear member. The intermittent gear member 50 includes a gear part 51 formed over the range of an angle of α1, a toothless part 52 formed over the range of an angle of α2 with no gear teeth, and a mechanism gear part 53. The intermittent gear member 50 is rotationally biased in the direction of the arrow B₂ by a torsion coil spring 54. The gear member 60 includes a gear part 61 and an arcuate cam part 62.

Initially, the gear part 51 and the gear part 61 are engaged with each other. When the gear member 60 is rotated in the direction of the arrow A₁, the intermittent gear member 50 is rotated in the direction of the arrow B₁. When the intermittent gear member 50 is rotated approximately an angle of α1, the gear part 61 is disengaged from the gear part 51, so that the cam part 62 opposes the toothless part 52. Thus, the transmission of rotation from the gear member 60 to the intermittent gear member 50 is cut off, so that the intermittent gear member 50 comes to a standstill. The intermittent gear member 50 is rotationally biased in the direction of the arrow B₂ by the torsion coil spring 54 so that an end tooth 51a of the gear part 51 comes into contact with the cam part 62 so as to restrict the rotation of the intermittent gear member 50. Thus, the intermittent gear member 50 is controlled to stay in this rotational position. When the gear member 60 is rotated a predetermined angle in the reverse direction indicated by arrow A₂, the cam part 62 is released from the toothless part 52, and the gear part 61 engages the gear part 51 so that the intermittent gear member 50 starts rotating in the direction of the arrow B₂.

### SUMMARY OF THE INVENTION

In the intermittent gear mechanism 10 of FIGS. 1A and 1B, the intermittent gear member 20 has the rotation stopper cam part 22 and the gear part 21 provided at different levels. Therefore, the intermittent gear member 20 becomes as thick as H₁ and is difficult to reduce in thickness.

In the intermittent gear mechanism 40 of FIGS. 2A and 2B, the intermittent gear member 50 does not include a rotation stopper cam part. Therefore, the intermittent gear member 50 has a reduced thickness of H₂. However, the end tooth 51a and the cam part 62 rub against each other so as to cause frictional wear, thus deleteriously affecting the useful life of the intermittent gear mechanism 40. Moreover, the torsion coil spring 54 requires an increase in the number of components of the intermittent gear mechanism 40.

Accordingly, it is a general object of the present invention to provide an intermittent gear member and an intermittent gear mechanism in which the above-described disadvantages are eliminated, and a magnetic recording and reproduction apparatus including the same.

More specific object of the present invention is to provide an intermittent gear member reduced in thickness, an intermittent gear mechanism reduced in the number of components and free of the problem of frictional wear, and a magnetic recording and reproduction apparatus using the same.

The above objects of the present invention are achieved by an intermittent gear member intermittently rotatable alternately in first and second opposite rotational directions within an angular range of 360° or less, the intermittent gear member including: a disk part; a gear part formed over a predetermined angular range on a circumferential surface of the disk part; and a rotation stopper cam part formed on a toothless part of the circumferential surface of the disk part so as to protrude therefrom, the toothless part corresponding to a range other than the range over which the gear part is formed, wherein the gear part and the rotation stopper cam part are provided in a single plane.

According to the above-described intermittent gear member, the gear part and the rotation stopper cam part are provided in the same plane. Therefore, the intermittent gear member of the present invention is reduced in thickness compared with the conventional intermittent gear member whose gear part and rotation stopper cam part are provided-in different planes.

The above objects of the present invention are also achieved by an intermittent gear mechanism including: a driving gear member rotatable alternately in first and second opposite rotational directions; and a driven gear member that is rotatable in a third rotational direction within an angular range of 360° or less by rotation transmitted from the driving gear member in the first rotational direction, stoppable at a position to which the driven gear member is rotated after the transmission of the rotation is cut off, and rotatable in a fourth rotational direction opposite to the third rotational direction by rotation transmitted from the driving gear member when the driving gear member rotates in the second rotational direction, wherein: the driving gear member includes a driving gear part formed circumferentially over a first predetermined angular range, and an arcuate cam part formed circumferentially adjacent to the driving gear part; and the driven gear member includes a disk part, a gear part formed over a second predetermined angular range on a circumferential surface of the disk part, and a rotation stopper cam part formed on a toothless part of the circumferential surface of the disk part so as to protrude therefrom and correspond to the arcuate cam part of the driving gear member, the toothless part corresponding to a range other than the range over which the gear part is formed, the gear part and the rotation stopper cam part being provided in a single plane.

The above-described intermittent gear mechanism includes an intermittent gear member of the present invention. Therefore, the intermittent gear mechanism of the present invention is reduced in thickness compared with the conventional intermittent gear mechanism.

The above objects of the present invention are further achieved by a magnetic recording and reproduction apparatus including: a holder transporting mechanism for transporting to a loading position a holder in which a tape cassette may be loaded; a rotary drum around which a magnetic tape of the tape cassette may be wound a predetermined angle so as to slide thereon; a tape guide member for guiding a running position of the magnetic tape pulled out of the tape cassette in the holder in the loading position; a shifting mechanism for shifting the tape guide member to a predetermined position; and an intermittent gear mechanism, the intermittent gear mechanism including: a driving gear member rotatable alternately in first and second opposite rotational directions; and a driven gear member that is rotatable in a third rotational direction within an angular range of 360° or less by rotation transmitted from the driving gear member in the first rotational direction, stoppable at a position to which the driven gear member is rotated after the transmission of the rotation is cut off, and rotatable in a fourth rotational direction opposite to the third rotational direction by rotation transmitted from the driving gear member when the driving gear member rotates in the second rotational direction, the driving gear member including a driving gear part formed circumferentially over a first predetermined angular range and an arcuate cam part formed circumferentially adjacent to the driving gear part, and the driven gear member including a disk part, a gear part formed over a second predetermined angular range on a circumferential surface of the disk part, and a rotation stopper cam part formed on a toothless part of the circumferential surface of the disk part so as to protrude therefrom and correspond to the arcuate cam part of the driving gear member, the toothless part corresponding to a range other than the range over which the gear part is formed, the gear part and the rotation stopper cam part being provided in a single plane, wherein the driven gear member of the intermittent gear mechanism is rotated in one of the third and fourth rotational directions so as to transport the holder to the loading position, and rotated in the other one of the third and fourth rotational directions so as to return the holder to an initial position thereof.

The above-described magnetic recording and reproduction apparatus includes an intermittent gear mechanism of the present invention. Therefore, the magnetic recording and reproduction apparatus of the present invention is reduced in thickness compared with the conventional magnetic recording and reproduction apparatus.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are diagrams showing a conventional intermittent gear mechanism;

FIGS. 2A and 2B are diagrams showing another conventional intermittent gear mechanism;

FIG. 3 is a perspective view of a magnetic recording and reproduction apparatus according to an embodiment of the present invention;

FIG. 4 is a plan view of the magnetic recording and reproduction apparatus according to the embodiment of the present invention;

FIG. 5 is a perspective view of a gear mechanism of the magnetic recording and reproduction apparatus according to the embodiment of the present invention;

FIGS. 6A and 6B are a perspective view and an elevational view, respectively, of an intermittent gear member according to the embodiment of the present invention;

FIGS. 7A and 7B are a perspective view and an elevational view, respectively, of a driving ring gear member according to the embodiment of the present invention;

FIG. 8 is a diagram showing an intermittent gear mechanism according to the embodiment of the present invention;

FIGS. 9A through 11B are diagrams showing a series of movements of the intermittent gear mechanism in the case of rotating the driving ring gear member in a first direction according to the embodiment of the present invention; and

FIG. 12A through 13 are diagrams showing a series of movements of the intermittent gear mechanism in the case of rotating the driving ring gear member in a second direction opposite to the first direction according to the embodiment of the present invention.

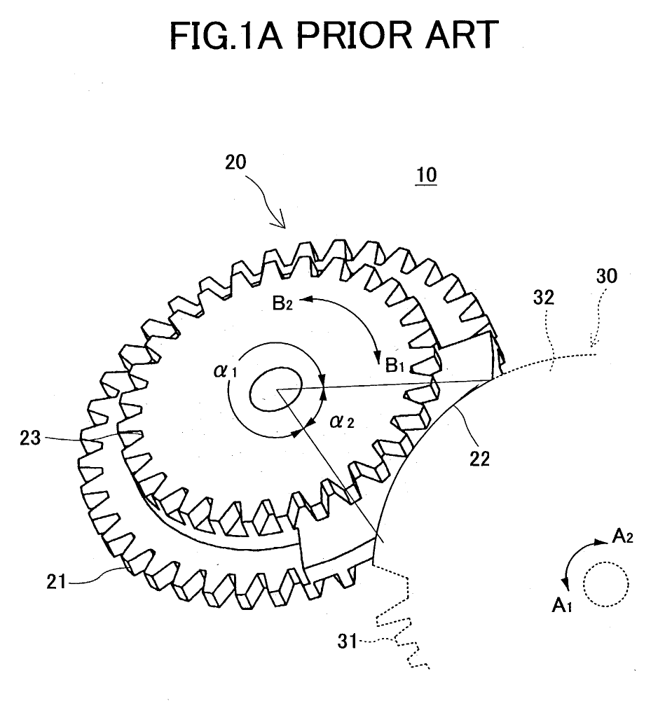

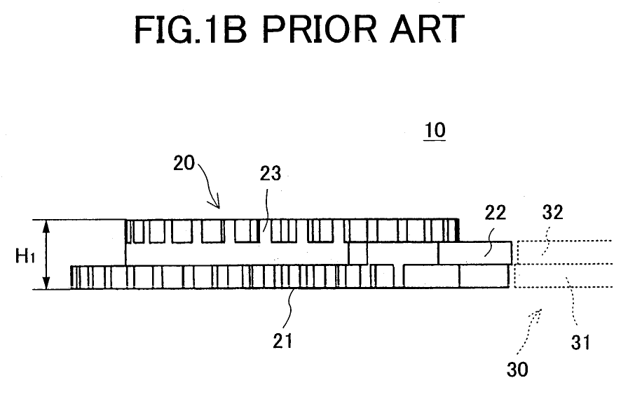

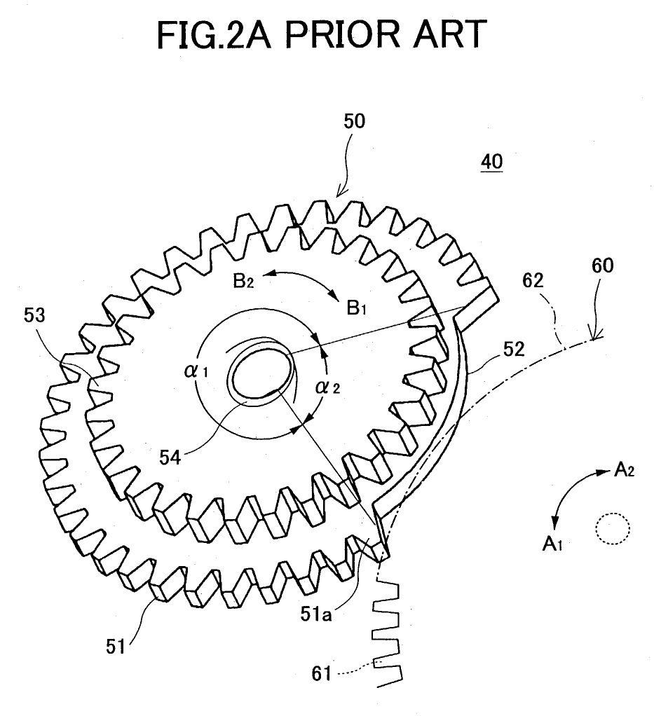

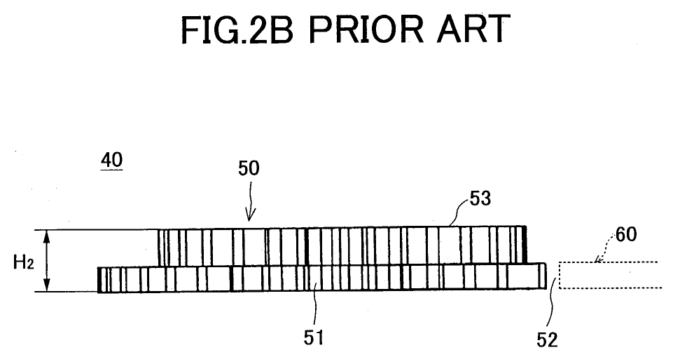

### DETAILED DESCRIPTION OF THE PREFERRED EMBODIMENTS

A description will now be given, with reference to the accompanying drawings, of an embodiment of the present invention.

First, a schematic description will be given, for convenience of description, of a magnetic recording and reproduction apparatus 100 to which an intermittent gear mechanism is applied according to the embodiment of the present invention.

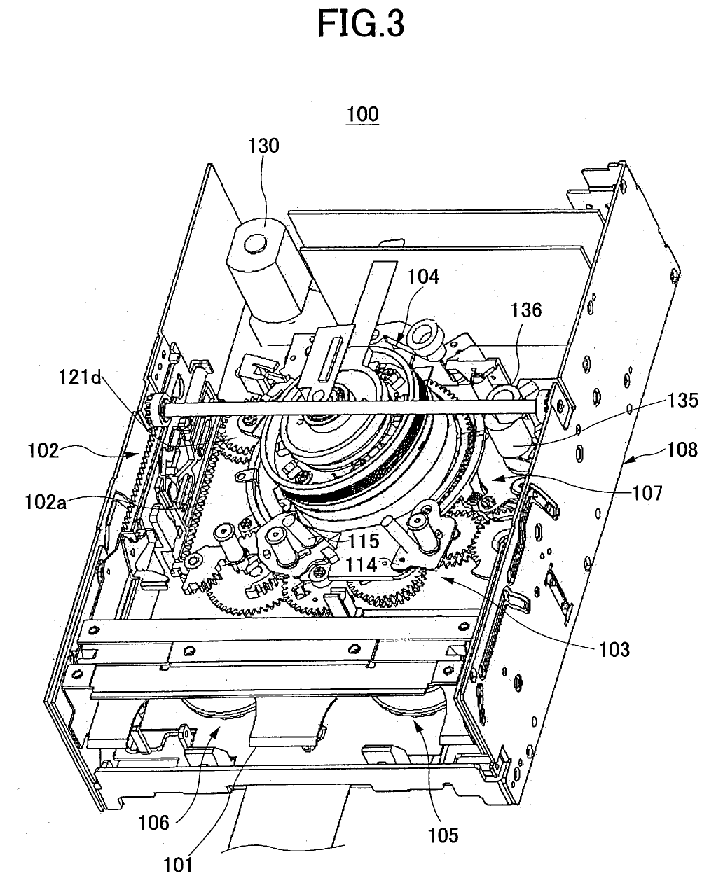

As shown in FIGS. 3 through 5, the magnetic recording and reproduction apparatus 100 is a streamer employed, for instance, as external storage for a computer. The magnetic recording and reproduction apparatus 100 includes: a holder 101 in which a tape cassette (not shown in the drawings) is inserted; a holder transporting mechanism 102 that transports the holder 100 to a loading position; a tape loading mechanism 103 that pulls out a magnetic tape (not shown in the drawings) wound around the reels of the tape cassette; a rotary drum unit 104 around which the magnetic tape is wound a predetermined angle by the tape loading mechanism 103; reel driving mechanisms 105 and 106 that rotate the reels of the tape cassette; a pinch roller mechanism 107; and a main chassis 108 supporting these mechanisms.

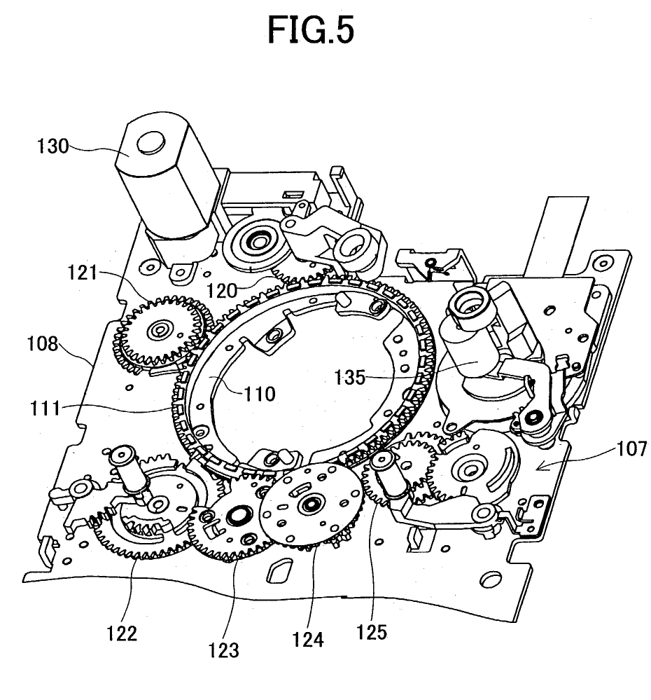

A support ring member 110 (FIG. 5) is fixed to the center of the main chassis 108. A driving ring gear member 111, an R ring gear member 112, and an L ring gear member 113 are superimposed to be supported by the support ring member 110 so as to be rotatable independent of one another. The driving ring gear member 111 may be formed of a material having a high sliding characteristic. A tape guide post unit 114 is fixed to the R ring gear member 112 and a tape guide post unit 115 is fixed to the L ring gear member 113.

As shown in FIG. 5, a gear member 120, an intermittent gear member 121, an intermittent gear member 122, a gear assembly 123, a gear assembly 124, and an intermittent gear member 125 are provided around the driving ring gear member 111 on the main chassis 108. The intermittent gear member 122 may be formed of a material having high rigidity.

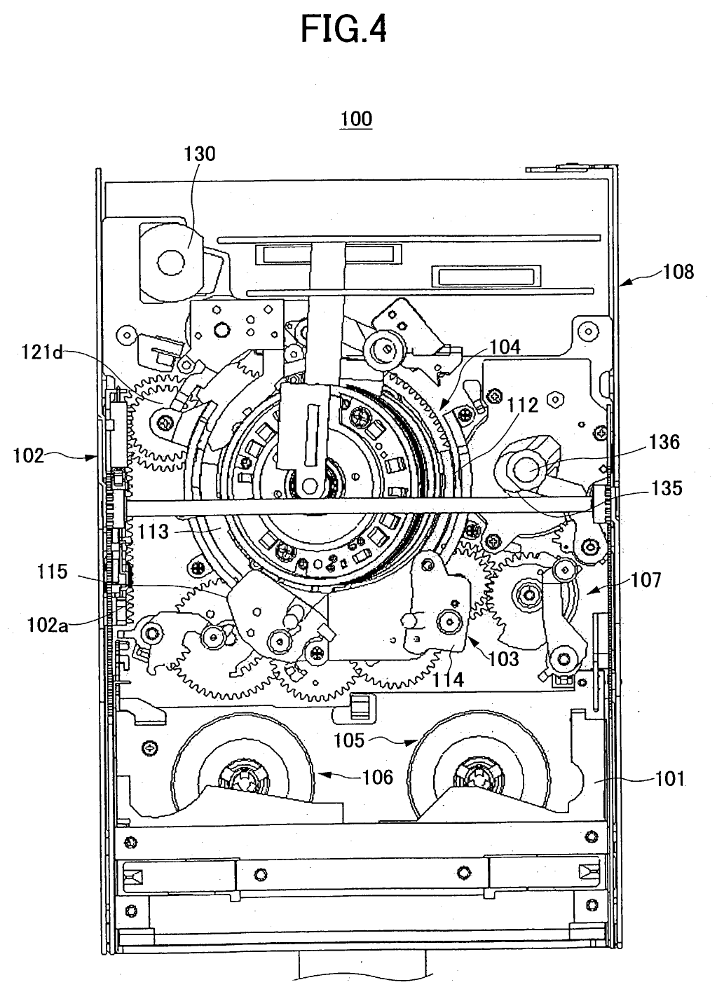

When a motor 130 is started, its rotation is transmitted through the gear member 120 to the driving ring gear member 111 so that the driving ring gear member 111 is rotated counterclockwise. During the transmission, the rotation is decelerated. The rotation of the driving ring gear member 111 is transmitted to the intermittent gear members 121, 122, and 125 (FIG. 5) in predetermined timing, so that the intermittent gear members 121, 122, and 125 are intermittently rotated. The rotation of the intermittent gear member 121 causes the holder transporting mechanism 102 (FIGS. 3 and 4) to operate to load the tape cassette. When the intermittent gear member 122 is rotated, the L ring gear member 113 is rotated clockwise via the gear assembly 123, and simultaneously, the R ring gear member 112 is rotated counterclockwise via the gear assemblies 123 and 124. As a result, the tape guide post units 114 and 115 are shifted so that the magnetic tape is pulled out of the tape cassette to be wound around the rotary drum unit 104. The rotation of the intermittent gear member 125 causes the pinch roller mechanism 107 to operate so that a pinch roller 135 presses the magnetic tape against a capstan 136, thereby pinching the magnetic tape.

The magnetic tape is driven, pinched and held by the pinch roller 135 and the capstan 136, so as to run back and forth along the rotary drum unit 104 so that information may be recorded on the magnetic tape.

Next, a description will be given of the intermittent gear member 121 and the driving ring gear member 111.

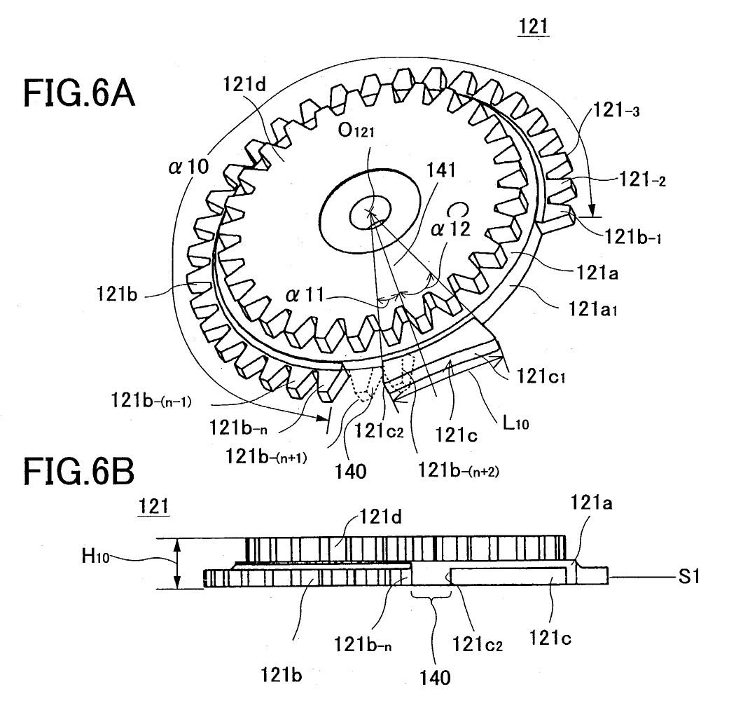

As shown in FIGS. 6A and 6B, the intermittent gear member 121 includes: a disk part 121a, a gear part 121b formed over a predetermined angular range of α10 on the circumferential surface of the disk part 121a; a rotation stopper cam part 121c formed like a flange protruding from a toothless part 121a₁ of the circumferential surface of the disk part 121a; and a gear part 121d disposed at the upper surface of the disk part 121a. No gear tooth is formed on the toothless part 121a₁, which is a part of the circumferential surface of the disk part 121a other than the part on which the gear part 121b is formed. The gear part 121b and the rotation stopper cam part 121c are provided in the same plane (or at the same level) S₁. The intermittent gear member 121 has a low-profile thickness of H₁₀.

The gear part 121b is formed of a plurality of gear teeth 121b₋₁ through 121b₋ₙ. Gear teeth 121b₋₍ₙ₊₁₎ and 121b₋₍ₙ₊₂₎ represented by the dotted lines in FIG. 6A are the first and second imaginary teeth in the case of extending the gear part 121b in the counterclockwise direction.

The rotation stopper cam part 121c has a cam surface 121c₁. The cam surface 121c₁, which is shaped so as to correspond to a later-described arcuate cam 111c of the driving ring gear member 111, has a concave arcuate shape.

A recess 140 is formed between the rotation stopper cam part 121c and the tooth 121b₋ₙ. An end face 121c₂ of the rotation stopper cam part 121c in the clockwise facing direction coincides with a (right) flank of the second imaginary tooth 121b₋₍ₙ₊₂₎ in the clockwise facing direction. This allows, as will be described later, a gear part 111b of the driving ring gear member 111 to smoothly engage the gear part 121b.

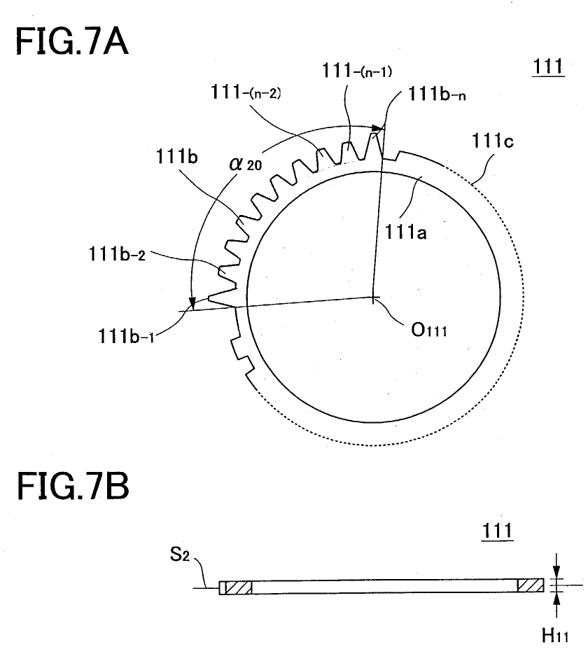

Reference numeral 141 denotes a line that connects the center O₁₂₁ of the intermittent gear member 121 and the center O111 of the driving ring gear member 111 (see FIGS. 7A and 7B) when the intermittent gear member 121 is in a stationary state. The rotation stopper cam part 121c has a projection angle of α11 in the clockwise direction with respect to the line 141 and a projection angle of α12 in the counterclockwise direction with respect to the line 141, where α12>α11. That is, the rotation stopper cam part 121c projects in the counterclockwise direction with respect to the line 141 (α12) at an angle larger than it projects in the clockwise direction with respect to the line 141 (α11). Therefore, the length L₁₀ of the cam surface 121c₁ is large so that the intermittent gear member 121 may be stably controlled to remain in a stationary or stopped state.

As shown in FIGS. 3 and 4, the gear part 121d is engaged with a rack 102a of the holder transporting mechanism 102.

As shown in FIGS. 7A and 7B, the driving ring gear member 111 includes: the gear part 111b formed over a predetermined angular range of α20 on the circumferential surface of a ring part 111a; and the arcuate cam part 111c circumferentially adjacent in the clockwise direction in FIG. 7A to the gear part 111b. The gear part 111b and the cam part 111c are positioned in the same plane (or at the same level) S2. The driving ring gear member 111 has a low-profile thickness of H₁₁. The gear part 111b is formed of a plurality of gear teeth 111b₋₁ through 111b₋ₙ. The first tooth 111b₋₁ and the last tooth 111b₋ₙ have a greater tooth depth than the other teeth 111b₋₂ through 111b₋₍ₙ₋₁₎ (that is, the teeth 111b₋₁ and 111b₋ₙ project a greater distance from the circumferential surface of the ring part 111a than the teeth 111b₋₂ through 111b₋₍ₙ₋₁₎) so as to ensure the later-described operation of pushing the rotation stopper cam part 121c. In this embodiment, both the first tooth 111b₋₁ and the last tooth 111b₋ₙ have a greater tooth depth than the other teeth 111b₋₂ through 111b_{31 (n-1)}. Alternatively, however, only the last tooth 111bₙ that pushes the rotation stopper cam part 121c may have a greater tooth depth than the other teeth 111b₋₁ through 111b₋₍ₙ₋₁₎.

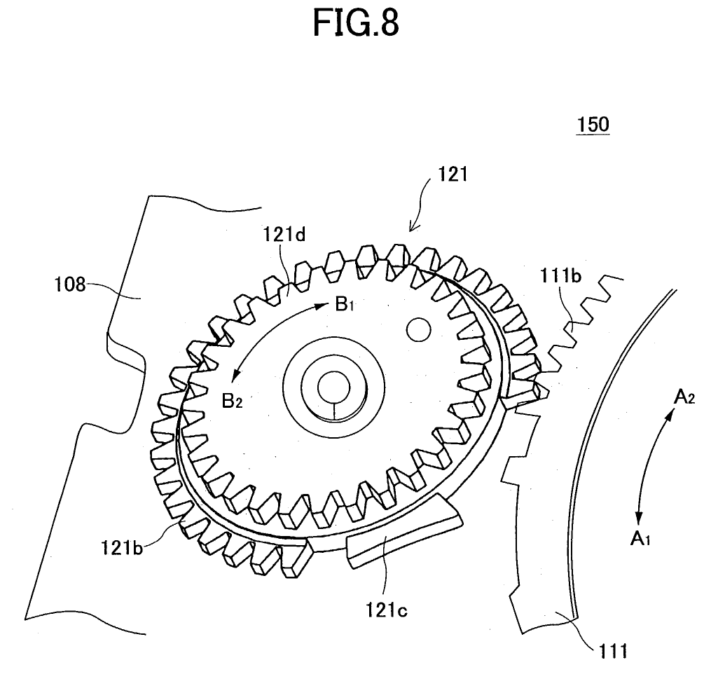

FIG. 8 is a diagram showing an intermittent gear mechanism 150. The intermittent gear mechanism 150 includes the driving ring gear member 111 as a driving gear member and the intermittent gear member 121 as a driven gear member that are engaged with each other.

Both the driving ring gear member 111 and the intermittent gear member 121 are low-profile, so that the intermittent gear mechanism 150 is reduced in thickness.

Next, a description will be given of the transmission of rotation in the intermittent gear mechanism 150.

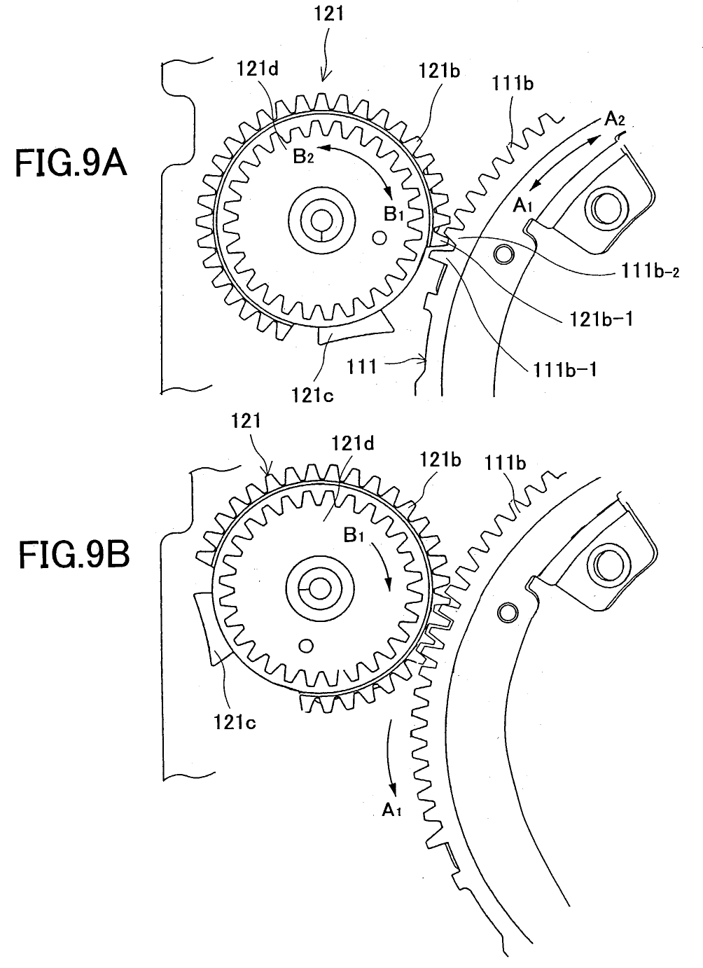

FIG. 9A is a diagram showing the initial state, wherein the tooth 121b₋₁ is engaged between the teeth 111b₋₁ and 111b₋₂.

The driving ring gear member 111 is rotated approximately 273° in the A₁ direction to come to a standstill. After being maintained in a stationary state, the driving ring gear member 111 is rotated in the A₂ direction to return to its initial (original) position.

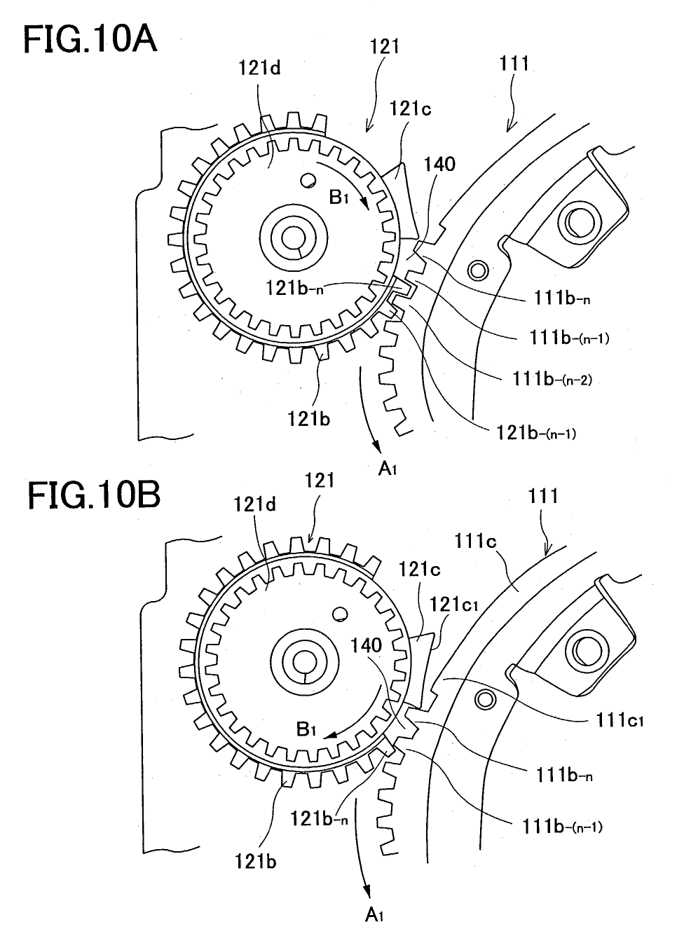

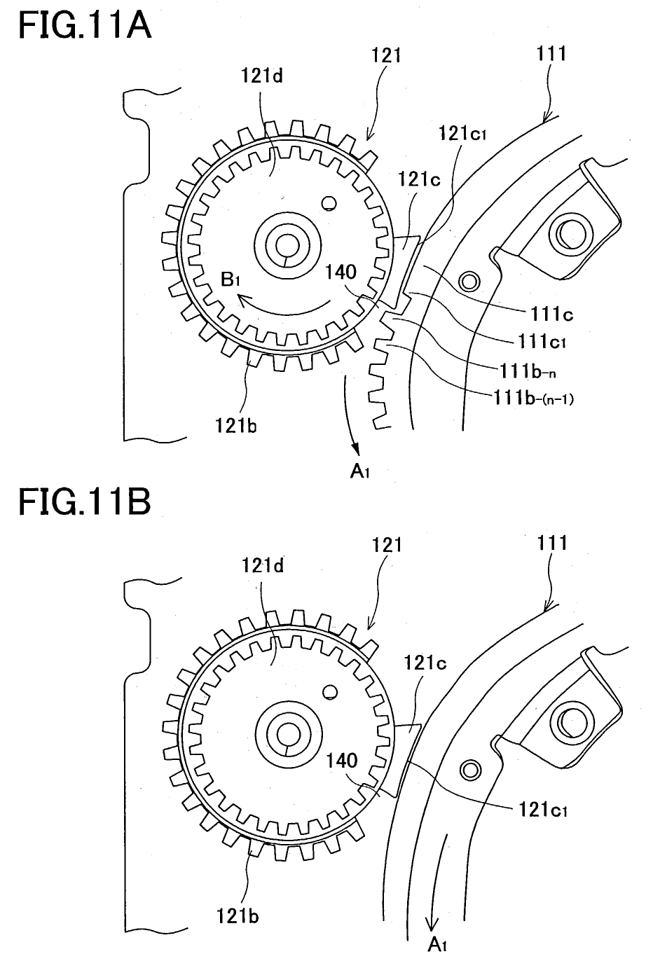

When the driving ring gear member 111 is rotated in the A₁ direction, the gear part 111b engages with the gear part 121b so as to start the rotation of the intermittent gear member 121 in the B₁ direction so that the state shown in FIG. 9B is entered. Thereafter, while continuing to rotate the driving ring gear member 111 in the A₁ direction, the state shown in FIG. 10A, the state shown in FIG. 10B, and the state shown in FIG. 11A are successively entered. In the state of FIG. 10A, the tooth 111b₋₍ₙ₋₂₎ engages between the teeth 121b₋₍ₙ₋₁₎ and 121b₋ₙ so that the intermittent gear member 121 is rotated in the B₁ direction, while the teeth 111b₋₍ₙ₋₁₎ and 111b₋ₙ are about to enter the recess 140 formed between the tooth 121b₋ₙ and the rotation stopper cam part 121c. In the state of FIG. 10B, the teeth 111b₋₍ₙ₋₁₎ and 111b₋ₙ have entered the recess 140 so that the tooth 111b₋₍ₙ₋₁₎ pushes the tooth 121b₋ₙ, while an end part 111c₁ of the cam part 111c is about to come into contact with the cam surface 121c₁ of the rotation stopper cam part 121c. In the state of FIG. 11A, the teeth 111b₋₍ₙ₋₁₎ and 111b₋ₙ are pulled out of the recess 140 while the end part 111c₁ of the cam part 111c comes into contact with the cam surface 121c₁ of the cam part 121c so that the rotation stopper cam part 121c is positioned along the cam part 111c.

Thereafter, the transmission of rotation in the A₁ direction from the driving ring gear member 111 to the intermittent gear member 121 is cut off, such that only the driving ring gear member 111 may rotate in the A₁ direction while the intermittent gear member 121 remains in a stationary state without rotating as shown in FIG. 11B. The intermittent gear member 121 is maintained at the position at which the intermittent gear member 121 is stopped with the position of the cam surface 121c₁ of the cam part 121c being controlled by the cam part 111c. When the intermittent gear member 121 is stopped, the cam surface 121c₁ of the cam part 121c is in contact with the circumferential surface of the cam part 111c of the driving ring gear member 111. Since the length L₁₀ (FIG. 6A) of the cam surface 121c₁ is increased, the intermittent gear member 121 is stably controlled to its stop position. That is, the cam surface 121c₁ of the rotation stopper cam part 121c, by having a larger surface from the line 141 in the counterclockwise direction than in the clockwise direction in FIG. 6A, provides stable control of the intermittent gear member 121 to its stop position. The pressure angle of the rotation stopper cam part 121c at the contact point of the cam surface 121c₁ (that is, α12) is preferably larger than or equal to 30° so as to prevent the cam part 111c of the driving ring gear member 111 from biting the rotation stopper cam part 121c when the driving ring gear member 111 rotates in the A₁ direction.

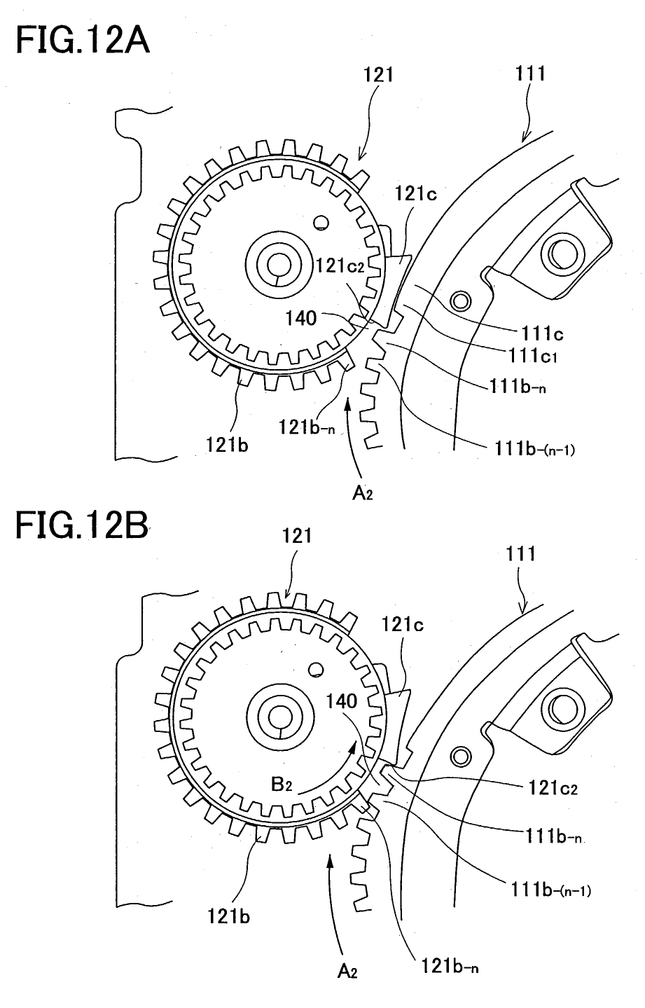

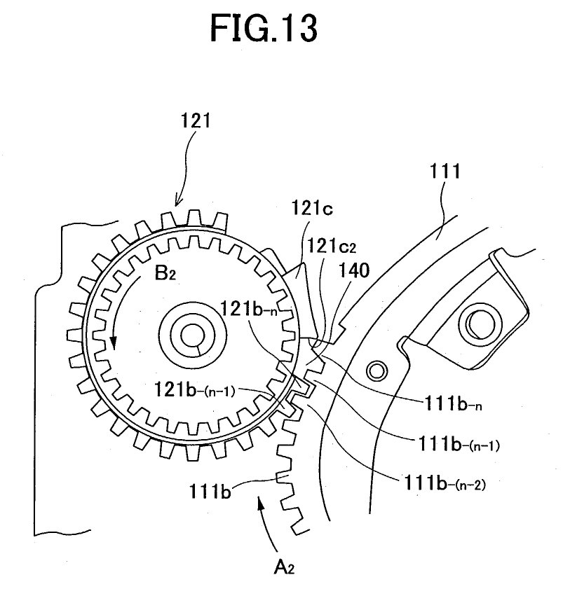

In the case of rotating the driving ring gear member 111 in the A₂ direction, the transmission of rotation to the intermittent gear member 121 is started after the rotation of the driving ring gear member 111 is started. In a reverse order of the above-described disengaging sequence, the gear part 111b and the gear part 121b start engaging each other successively through the state of FIG. 12A, which corresponds to FIG. 11A, the state of FIG. 12B, which corresponds to FIG. 10B, and the state of FIG. 13, which corresponds to FIG. 10A.

FIG. 12A shows the state where the end part 111c₁ of the cam part 111c reaches the cam surface 121c₁ of the rotation stopper cam part 121c while the tooth 111b₋ₙ is about to come into contact with the end face 121c₂ of the rotation stopper cam part 121c. The greater tooth depth of the tooth 111b₋ₙ ensures that the tooth 111b₋ₙ comes into contact with the end face 121c₂ of the rotation stopper cam part 121c.

FIG. 12B shows the state where the tooth 111b₋ₙ pushes the end face 121c₂ of the rotation stopper cam part 121c to rotate the intermittent gear member 121 in the B₂ direction so that the teeth 111b₋₍ₙ₋₁₎ and 111b₋ₙ enter the recess 140.

FIG. 13 shows the state where the tooth 111b₋₍ₙ₋₂₎ is engaged between the teeth 121b₋₍ₙ₋₁₎ and 121b₋ₙ while the teeth 111b₋₍ₙ₋₁₎ and 111b₋ₙ are pulled out of the recess 140.

As was mentioned above, the end face 121c₂ of the rotation stopper cam part 121c coincides with the right flank of the second imaginary tooth 121b−(n+2) (FIG. 6A) This facilitates the teeth 111b₋₍ₙ₋₁₎ and 111b₋ₙ fitting in the recess 140 smoothly and the tooth 111b₋₍ₙ₋₂₎ also smoothly engaging between the teeth 121b₋₍ₙ₋₁₎ and 121b₋ₙ, so that the gear part 111b of the driving ring gear member 111 smoothly engages with the gear part 121b of the intermittent gear member 121.

Thereafter, the transmission of rotation from the driving ring gear member 111 to the intermittent gear member 121 is started, and the initial state of FIG. 9A may be entered via the state of FIG. 9B.

Since no spring member for rotationally biasing the intermittent gear member 121 is necessary, the intermittent gear mechanism 150 has a reduced number of components compared with the above-described prior-art intermittent gear mechanism 40. Further, since the intermittent gear member 121 is not rotationally biased, the problem of frictional wear is prevented from occurring.

The present invention is not limited to the specifically disclosed embodiment, and variations and modifications may be made without departing from the scope of the present invention.

The present application is based on Japanese priority application No. 2002-178241, filed on Jun. 19, 2002, the entire contents of which are hereby incorporated by reference.

What is claimed is:

1. An intermittent gear member intermittently rotatable alternately in first and second opposite rotational directions within an angular range of 360° or less, the intermittent gear member comprising:
a disk part;
a gear part formed over a predetermined angular range on a circumferential surface of said disk part; and
a rotation stopper cam part formed on a toothless part of the circumferential surface of said disk part so as to protrude therefrom, the toothless part corresponding to a range other than the range over which said gear part is formed,
wherein said gear part and said rotation stopper cam part are provided in a single plane.

2. The intermittent gear member as claimed in claim 1, wherein said rotation stopper cam part is formed so that an end face thereof facing in the first rotational direction coincides with a flank of an imaginary gear tooth of said gear part facing in the first rotational direction.

3. The intermittent gear member as claimed in claim 1, wherein said rotation stopper cam part is formed so that an end face thereof facing in the first rotational direction is spaced from a flank of a gear tooth of said gear part facing in the first rotational direction by a plurality of reference pitches.

4. The intermittent gear member as claimed in claim 1, wherein said rotation stopper cam part has an asymmetrical shape with respect to a radial direction of said disk part.

5. An intermittent gear mechanism comprising:
a driving gear member rotatable alternately in first and second opposite rotational directions; and
a driven gear member that is rotatable in a third rotational direction within an angular range of 360° or less by rotation transmitted from said driving gear member in the first rotational direction, stoppable at a position to which the driven gear member is rotated after the transmission of the rotation is cut off, and rotatable in a fourth rotational direction opposite to the third rotational direction by rotation transmitted from said driving gear member when said driving gear member rotates in the second rotational direction,
wherein:
said driving gear member comprises:
a driving gear part formed circumferentially over a first predetermined angular range; and
an arcuate cam part formed circumferentially adjacent to said driving gear part; and
said driven gear member comprises:
a disk part;
a gear part formed over a second predetermined angular range on a circumferential surface of said disk part; and
a rotation stopper cam part formed on a toothless part of the circumferential surface of said disk part so as to protrude therefrom and correspond to said arcuate cam part of said driving gear member, the toothless part corresponding to a range other than the range over which said gear part is formed,
said gear part and said rotation stopper cam part being provided in a single plane.

6. The intermittent gear mechanism as claimed in claim 5, wherein:
said driving gear part of said driving gear member comprises a plurality of gear teeth; and
at least one of the end gear teeth of the plurality of gear teeth positioned at ends of said driving gear part that comes into contact with said rotation stopper cam part of said driven gear member has a greater tooth depth than at least one of the gear teeth positioned between the end gear teeth.

7. A magnetic recording and reproduction apparatus comprising: a holder transporting mechanism for transporting to a loading position a holder in which a tape cassette may be loaded; a rotary drum around which a magnetic tape of the tape cassette may be wound a predetermined angle so as to slide thereon; a tape guide member for guiding a running position of the magnetic tape pulled out of the tape cassette in the holder in the loading position; a shifting mechanism for shifting the tape guide member to a predetermined position; and
an intermittent gear mechanism,
the intermittent gear mechanism comprising:
a driving gear member rotatable alternately in first and second opposite rotational directions; and
a driven gear member that is rotatable in a third rotational direction within an angular range of 360° or less by rotation transmitted from said driving gear member in the first rotational direction, stoppable at a position to which the driven gear member is rotated after the transmission of the rotation is cut off, and rotatable in a fourth rotational direction opposite to the third rotational direction by rotation transmitted from said driving gear member when said driving gear member rotates in the second rotational direction,
said driving gear member comprising:
a driving gear part formed circumferentially over a first predetermined angular range; and
an arcuate cam part formed circumferentially adjacent to said driving gear part; and
said driven gear member comprising:
a disk part;
a gear part formed over a second predetermined angular range on a circumferential surface of said disk part; and
a rotation stopper cam part formed on a toothless part of the circumferential surface of said disk part so as to protrude therefrom and correspond to said arcuate cam part of said driving gear member, the toothless part corresponding to a range other than the range over which said gear part is formed,
said gear part and said rotation stopper cam part being provided in a single plane,
wherein said driven gear member of said intermittent gear mechanism is rotated in one of the third and fourth rotational directions so as to transport the holder to the loading position, and rotated in the other one of the third and fourth rotational directions so as to return the holder to an initial position thereof.

8. The magnetic recording and reproduction apparatus as claimed in claim 7, wherein said intermittent gear member is provided at a position of the holder transporting member.

9. The magnetic recording and reproduction apparatus as claimed in claim 7, wherein:
said driving gear part of said driving gear member of said intermittent gear mechanism comprises a plurality of gear teeth; and
at least one of the end gear teeth of the plurality of gear teeth positioned at ends of said driving gear part that comes into contact with said rotation stopper cam part of said driven gear member has a greater tooth depth than at least one of the gear teeth positioned between the end gear teeth.
